(19) United States
(12) Patent Application Publication
(10) Pub. No.: US 2019/0376007 A1
(43) Pub. Date: Dec. 12, 2019

(54) USE OF LAUNDRY SERUM

(71) Applicant: Conopco, Inc., d/b/a UNILEVER, Englewood Cliffs, NJ (US)

(72) Inventors: Martin Charles Crossman, Merseyside (GB); Julie Cullen, Merseyside (GB); Karl Burgess, Merseyside (GB)

(21) Appl. No.: 16/485,599

(22) PCT Filed: Feb. 9, 2018
(86) PCT No.: PCT/EP2018/053305

§ 371 Date: Aug. 13, 2019

(30) Foreign Application Priority Data
Feb. 13, 2017 (EP) 17155812.5

(51) Int. Cl. C11D 3/37; C11D 11/00; C11D 17/00; C11D 3/00; C11D 3/22; C11D 3/50

(52) U.S. Cl. CPC C11D 3/373; C11D 11/0017; C11D 17/0017; C11D 3/505; C11D 3/222; C11D 3/3757; C11D 3/0015

(57) ABSTRACT

Use of a serum comprising a lubricant for anti-aging of clothes.

### FIELD OF THE INVENTION

The present invention relates to the use of a serum comprising a lubricant for anti-aging of clothes.

### BACKGROUND OF THE PRESENT INVENTION

It is well known that clothes age over time, due to the various external factors including the washing process and through wear. After a certain degree of aging, consumers judge the clothes to be no longer suitable for wear.

In an age of environmentally conscious consumers, consumers are striving to make their clothes last longer. Clothes lasting longer, reduces the frequency with which consumers buy new clothes. This in turn reduces the strains on the planet's resources and reduces the impact on the environment that the demand for new material causes.

There is a desire for laundry products which provide the benefit of anti-aging.

A culmination of various different factors cause clothes to look aged. Combinations of factors such as: stretching of fabrics, fading, bobbling, changing in drape characteristics, loss of shape etc, are often quoted as reasons why clothes look old. Materials have been identified to prevent individual factors, however there is a need for a material which provides an overall anti-aging benefit to fabrics.

Surprisingly it has been found that serums comprising a lubricant can be used to provide an antiaging benefit.

### SUMMARY OF THE PRESENT INVENTION

In a first aspect of the present invention is provided the use of a serum comprising a lubricant for anti-aging of clothes.

In a second aspect of the present invention is provided use of a serum as described herein, wherein the method of use comprises the steps of:

a. Pouring a laundry liquid into a washing machine drawer, drum or a dosing shuttle
b. Pouring a serum composition according to the invention on top of the laundry liquid.

### DETAILED DESCRIPTION OF THE PRESENT INVENTION

The term ‘serum’ is used to refer to a specific format of laundry product. This may also be referred to as a ‘laundry serum’. This is a liquid product which is used in addition to the laundry detergent and/or the fabric conditioner to provide an additional or improved benefit to the materials in the wash or rinse cycle. A serum may also be referred to as a liquid ancillary composition.

The term ‘laundry liquid’ is used to refer to traditional liquids used in the laundry process, particularly liquid laundry detergents and liquid laundry fabric conditioners/softener.

Throughout this specification density is measured by weighing a known volume of sample using a ‘Sheen’ density cup with lid on a 4 figure balance.

Throughout this specification viscosity measurements were carried out at 25° C., using a 4 cm diameter 2° cone and plate geometry on a DHR-2 rheometer ex. TA instruments.

In detail, all measurements were conducted using a TA-Instruments DHR-2 rheometer with a 4 cm diameter 2 degree angle cone and plate measuring system. The lower Peltier plate was used to control the temperature of the measurement to 25° C. The measurement protocol was a ‘flow curve’ where the applied shear stress is varied logarithmically from 0.01 Pa to 400 Pa with 10 measurement points per decade of stress. At each stress the shear strain rate is measured over the last 5 seconds of the 10 second period over which the stress is applied with the viscosity at that stress being calculated as the quotient of the shear stress and shear rate.

For those systems which exhibit a low shear viscosity plateau over large shear stress ranges, to at least 1 Pa, the characteristic viscosity is taken as being the viscosity at a shear stress of 0.3 Pa. For those systems where the viscosity response is shear thinning from low shear stress the characteristic viscosity is taken as being the viscosity at a shear rate of 21 s−1.

Anti-Aging

Anti-aging is an effect resulting from preventative measures rather than a reactive measures. i.e. antiaging prevents aging rather than fixes aging once it has occurred. Anti-ageing means the reduction or prevention of ageing. For example anti-aging is the reduction of the speed at which clothes age. This is due to the prevention or reduction of the effects of a combination of stressors causing clothes to look old. Anti-aging may be expressed in various different ways, such as:
Damage Defy
Help keep clothes looking like new for longer
Reduction or prevention of ageing

### Serum Composition

The serum composition preferably comprises:

a. 1-60 w.t. % lubricant;
b. less than 4 w.t. % surfactant; and
c. water

The viscosity of the laundry composition is preferably 400-15000 Pa·s.

If the serum is used in conjunction with a laundry liquid, preferably, the serum floats on the, laundry liquid with which it is used. By float it is meant that the serum will remain at the surface of the laundry liquid for a period of at least 5 minutes, preferably 10 minutes and most preferably at least 15 minutes. Floating provides the benefit the laundry liquid carries the serum into the laundry process.

To enable the serum to float, it is not essential that it is less dense than the laundry liquid with which it is being used, however it is preferred that the serum is less dense than the laundry liquid with which it is used. This density provides the benefit the laundry liquid carries the serum into the laundry process.

The serum composition is preferably not miscible with a laundry liquid with which it is used. The inadmissibility prevents mixing of the serum composition and laundry liquid and ensures maximum performance of the serum.

Lubricant

Lubricants may be silicone based lubricants or non-silicone based lubricants.

Examples of non-silicone based lubricants include clays, waxes, polyolefins, sugar polyesters, synthetic and natural oils.

For the purposes of this invention, lubricants do not include fabric softening quaternary ammonium compounds.

Preferably the lubricant is a silicone based lubricant. Silicones and their chemistry are described in, for example in The Encyclopaedia of Polymer Science, volume 11, p 765.

Silicones suitable for the present invention are fabric softening silicones. Non-limiting examples of such silicones include: non-functionalised silicones such as polydialkylsiloxanes, particularly polydimethylsiloxane (PDMS), alkyl (or alkoxy) functionalised silicones, and functionalised silicones or copolymers with one or more different types of functional groups such as amino, phenyl, polyether, acrylate, siliconhydride, carboxy acid, phosphate, betaine, quarternized nitrogen and mixtures thereof.

The molecular weight of the silicone is preferably from 1,000 to 500,000, more preferably from 2,000 to 250,000 even more preferably from 5,000 to 100,000.

The silicone composition of the current invention may be in the form of an emulsion or as a silicone fluid. In a preferred embodiment the silicone is in the form of a silicone emulsion.

When the silicone is in an emulsion, the particle size can be in the range from about 1 nm to 100 microns and preferably from about 10 nm to about 10 microns including microemulsions (<150 nm), standard emulsions (about 200 nm to about 500 nm) and macroemulsions (about 1 micron to about 20 microns).

The fabric softening silicones may be an emulsion or a fluid, preferably an emulsion.

Preferred non-functionalised silicones are polydialkylsiloxanes, most preferred non-functionalised silicones are polydimethylsiloxane (PDMS).

Preferred functionalised silicones are an anionic functionalised silicone. Examples of fabric softening anionic silicones suitable for the current invention include silicones containing the following functionalities; carboxylic, sulphate, sulphonic, phosphate and/or phosphonate functionality.

Preferably the anionic silicones of the current invention comprise silicones having a functionality selected from; carboxylic, sulphate, sulphonic, phosphate and/or phosphonate functionality or mixtures thereof. More preferably the anionic silicone of the present invention comprises carboxyl functionalised silicones. Most preferably the anionic silicone of the current invention is a carboxyl silicone.

For the purposes of the current invention, the anionic silicone may be in the form of the acid or the anion. For example for a carboxyl functionalised silicone, may be present as a carboxylic acid or carboxylate anion.

An example of a commercially available anionic functional material are: X22-3701E from Shin Etsu and Pecosil PS-100 from Pheonix Chemical.

Preferably the anionic silicone has an anionic group content of at least 1 mol %, preferably at least 2 mol %.

The anionic group(s) on the anionic silicones of the present invention are preferably located in pendent positions on the silicone i.e. the composition comprises anionic silicones wherein the anionic group is located in a position other than at the end of the silicone chain. The terms ‘terminal position’ and ‘at the end of the silicone chain’ are used to indicate the terminus of the silicone chain.

When the silicones are linear in nature, there are two ends to the silicone chain. In this case the anionic silicone preferably contains no anionic groups located on a terminal position of the silicone.

When the silicones are branched in nature, the terminal position is deemed to be the two ends of the longest linear silicone chain. Preferably no anionic functionality is not located on the terminus of the longest linear silicone chain.

Preferred anionic silicones are those that comprise the anionic group at a mid-chain position on the silicone. Preferably the anionic group(s) of the anionic silicone are located at least five Si atoms from a terminal position on the silicone. Preferably the anionic groups are distributed randomly along the silicone chain.

Most preferably the silicone of the present invention is selected from polydimethylsiloxane (PDMS) and carboxy functionalised silicones, preferred carboxy functionalised silicones are described above.

The lubricant is present in a level of 1 to 60 w.t. % of the formulation, preferably 2 to 30 w.t. % of the formulation, more preferably 2.5 to 20 w.t. % of the formulation.

Surfactant The serum composition of the present invention is not a traditional laundry detergent or fabric conditioning composition. The present invention preferably comprises low levels or no surfactants. Any surfactant present is preferably for the purpose of emulsifying and not for detergency or softening.

The serum of the present invention comprises less than 4 w.t. % surfactant, preferably less than 2 w.t. % surfactant, more preferably less than 1 w.t. % surfactant, even more preferably less than 0.85 w.t. % surfactant and most preferably less than 0.5 w.t. %. The composition can be completely surfactant free of non-emulsified surfactant (ie surfactant not-used to emulsify the droplet).

In other words, the compositions may comprise 0 to 4 w.t. % surfactant, preferably, the composition of the present invention comprises 0 to 2 w.t. % surfactant, more preferably, 0 to 1 w.t. % surfactant, even more preferably 0 to 0.85 w.t. % and most preferably 0 to 0.5 w.t. %. The composition can be completely surfactant free of non-emulsified surfactant (ie surfactant not-used to emulsify the droplet).

The term surfactant covers all categories of surfactant, including: anionic, cationic, non-ionic and zwitterion surfactants. Many surfactants are traditionally used in laundry compositions: laundry detergent compositions often comprise anionic and non-ionic surfactants whereas fabric conditioning compositions often comprise cationic surfactants.

The composition of the present invention is not a traditional laundry detergent or fabric conditioning composition. The present invention preferably comprises low levels or no surfactants. Any surfactant present is preferably for the purpose of emulsifying the silicone ant not for detergency or softening.

Cationic Polymer

The serum of the present invention preferably comprises a cationic polymer. This refers to polymers having an overall positive charge.

The cationic polymer may be naturally derived or synthetic. Examples of suitable cationic polymers include: acrylate polymers, cationic amino resins, cationic urea resins, and cationic polysaccharides, including: cationic celluloses, cationic guars and cationic starches.

The cationic polymer of the present invention may be categorised as a polysaccharide-based cationic polymer or non-polysaccharide based cationic polymers.

Polysaccharide-Based Cationic Polymers:

Polysacchride based cationic polymers include cationic celluloses, cationic guars and cationic starches. Polysaccharides are polymers made up from monosaccharide monomers joined together by glycosidic bonds.

The cationic polysaccharide-based polymers present in the compositions of the invention have a modified polysaccharide backbone, modified in that additional chemical groups have been reacted with some of the free hydroxyl groups of the polysaccharide backbone to give an overall positive charge to the modified cellulosic monomer unit.

Non Polysaccharide-Based Cationic Polymers:

A non-polysaccharide-based cationic polymer is comprised of structural units, these structural units may be non-ionic, cationic, anionic or mixtures thereof. The polymer may comprise non-cationic structural units, but the polymer must have a net cationic charge.

The cationic polymer may consists of only one type of structural unit, i.e., the polymer is a homopolymer. The cationic polymer may consists of two types of structural units, i.e., the polymer is a copolymer. The cationic polymer may consists of three types of structural units, i.e., the polymer is a terpolymer. The cationic polymer may comprises two or more types of structural units. The structural units may be described as first structural units, second structural units, third structural units, etc. The structural units, or monomers, may be incorporated in the cationic polymer in a random format or in a block format.

The cationic polymer may comprise a nonionic structural units derived from monomers selected from: (meth)acrylamide, vinyl formamide, N, N-dialkyl acrylamide, N, N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and mixtures thereof.

The cationic polymer may comprise a cationic structural units derived from monomers selected from: N, N-dialkylaminoalkyl methacrylate, N, N-dialkylaminoalkyl acrylate, N, N-dialkylaminoalkyl acrylamide, N, N-dialkylaminoalkylmethacrylamide, methacylamidoalkyl trialkylammonium salts, acrylamidoalkylltrialkylamminium salts, vinylamine, vinylimine, vinyl imidazole, quatemized vinyl imidazole, diallyl dialkyl ammonium salts, and mixtures thereof.

Preferably, the cationic monomer is selected from: diallyl dimethyl ammonium salts (DADMAS), N, N-dimethyl aminoethyl acrylate, N,N-dimethyl aminoethyl methacrylate (DMAM), [2-(methacryloylamino)ethyl]tri-methylammonium salts, N, N-dimethylaminopropyl acrylamide (DMAPA), N, N-dimethylaminopropyl methacrylamide (DMAPMA), acrylamidopropyl trimethyl ammonium salts (APTAS), methacrylamidopropyl trimethylammonium salts (MAPTAS), quatemized vinylimidazole (QVi), and mixtures thereof.

The cationic polymer may comprise a anionic structural units derived from monomers selected from: acrylic acid (AA), methacrylic acid, maleic acid, vinyl sulfonic acid, styrene sulfonic acid, acrylamidopropylmethane sulfonic acid (AMPS) and their salts, and mixtures thereof.

Some cationic polymers disclosed herein will require stabilisers i.e. materials which will exhibit a yield stress in the serum of the present invention. Such stabilisers may be selected from: thread like structuring systems for example hydrogenated castor oil or trihydroxystearin e.g. Thixcin ex. Elementis Specialties, crosslinked polyacrylic acid for example Carbopol ex. Lubrizol and gums for example carrageenan.

Preferably the cationic polymer is selected from; cationic polysaccharides and acrylate polymers. More preferably the cationic polymer is a cationic polysaccharide.

The molecular weight of the cationic polymer is preferably greater than 20 000 g/mol, more preferably greater than 25 000 g/mol. The molecular weight is preferably less than 2 000 000 g/mol, more preferably less than 1 000 000 g/mol.

Serum according to the current invention preferably comprise cationic polymer at a level of 0.25 to 10 w.t. % of the formulation, preferably 0.35 to 7.5 w.t. % of the formulation, more preferably 0.5 to 5 w.t. % of the formulation

Rheology Modifier

In some embodiments of the present invention, the serum of the present invention may comprise rheology modifiers. These may be inorganic or organic, polymeric or non polymeric. A preferred type of rheology modifiers are salts.

Perfumes

The serum of the present invention preferably comprises a perfume composition. Perfume may be provided either as a free oil and/or in a microcapsule.

The serum of the present invention may comprise one or more perfume compositions. The perfume compositions may be in the form of a mixture or free perfumes compositions, a mixture of encapsulated perfume compositions or a mixture of encapsulated and free oil perfume compositions.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Free oil perfumes and fragrances may be added to the serum. These may be to scent the serum, to provide scent in the washing process or to provide scent to the textiles after the wash.

Particularly preferred perfume components are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume ingredients may be applied.

Free perfume may preferably be present in an amount from 0.01 to 20% by weight, more preferably from 0.05 to 10% by weight, even more preferably from 0.1 to 5.0%, most preferably from 0.15 to 5.0% by weight, based on the total weight of the composition.

When perfume components are in a microcapsule, suitable encapsulating material, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or profragrance materials.

Particularly preferred perfume components contained in a microcapsule are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume ingredients may be applied.

Encapsulated perfume may preferably be present in an amount from 0.01 to 20% by weight, more preferably from 0.05 to 10% by weight, even more preferably from 0.1 to 5.0%, most preferably from 0.15 to 5.0% by weight, based on the total weight of the composition.

If the serum comprises a microcapsules, a structurant may be required, non-limiting examples of suitable structurants include: pectine, alginate, arabinogalactan, carageenan, gellan gum, xanthum gum, guar gum, acrylates/acrylic polymers, water-swellable clays, fumed silicas, acrylate/aminoacrylate copolymers, and mixtures thereof. Preferred dispersants herein include those selected from the group consisting of acrylate/acrylic polymers, gellan gum, fumed silicas, acrylate/aminoacrylate copolymers, water-swellable clays, and mixtures thereof. Preferably a structurant is selected from acrylate/acrylic polymers, gellan gum, fumed silicas, acrylate/aminoacrylate copolymers, water-swellable clays, and mixtures thereof.

When present, a structurant is preferably present in an amount of 0.001-10 w.t. % percent, preferably from 0.005-5 w.t. %, more preferably 0.01-1 w.t. %.

Other Ingredients

The serum of the present invention may comprise any other optional laundry ingredients such as: Non-limiting examples of suitable benefit agents include: lubricants (including silicones), antifoams, free perfumes and fragrances, encapsulated perfumes and fragrances, insect repellents, whiteness agents (eg shading or hueing dyes and/or fluorescers), preservatives (e.g. bactericides), enzymes (eg protease, lipases, cellulases, pectate lyase), dye transfer inhibitors, pH buffering agents, perfume carriers, anti-bacterial agenat, fibre adhesives (eg starch, Polyvinyl acetate), elastomers, anti-microbial agents, anti-redeposition agents, soil-release agents, softening agents, polyelectrolytes, anti-shrinking agents, anti-wrinkle agents, anti-oxidants, dyes, colorants, shade enhancers, fluorescent agents, sunscreens, anti-corrosion agents, anti-static agents, sequestrants (preferably HEDP, an abbreviation for Etidronic acid or 1-hydroxyethane 1,1-diphosphonic acid), colour preservatives, fungicides, pearlisers and/or opacifiers and ironing aids.

Method of Using the Serum:

The serum of the present invention is used in addition to a laundry liquid.

Preferably the serum is added to the laundry process with a laundry liquid. By this is meant that the serum is add to the laundry process at the same time as a laundry liquid. This may be at the same time as the laundry detergent or at the same time as the fabric conditioner.

The serum may be added to the drawer of a washing machine or the drum of a washing machine. By drawer it is meant any one of the compartments in the drawer of a washing machine. When added to the drum, this may be direct addition into the drum or via a dosing ball. A dosing ball is preferred. By dosing ball is meant any form of container which would usually hold a laundry detergent composition and be placed directly in a washing machine.

Preferably the Method of Use Comprises the Steps of:

a. Pouring a laundry liquid into a washing machine drawer, drum or a dosing shuttle
b. Pouring a serum composition according to any preceding claim on top of the laundry liquid

Preferably the serum is poured into a washing machine drawer or a dosing ball, and then the liquid ancillary composition is poured on top of the laundry liquid in the drawer or dosing ball.

It has been found that adding the serum to the drum or the drawer both provide anti-aging benefits. Preferably the serum is added to the drum for best results.

Preferably the serum is used in a volume of 2-50 ml, more preferably a volume of ml 2-30 ml, most preferably 2-20 ml.

### EXAMPLES

Example Serum Composition:

TABLE 1
Silicone Serum Formulation 1

| | w.t. % |
|---|---|
| Active silicone¹ | 5 |
| Cationic polymer² | 2 |
| Minors | <5% |
| NaOH | To pH 7.0-8.0 |
| Water | To 100 |

Silicone¹ - Silicone added as a 30% emulsion ex. Wacker Silicone. The silicone comprised a carboxy group in a mid-chain pendent position.
Cationic polymer² - Ucare ™ polymer LR400 ex. Dow

Method of Producing Example Serum:

Demineralised water was added to the silicone emulsion¹ and mixed for 15 mins at 250 rpm using a Janke & Kunkel IKA RW20 overhead mixer. The solid deposition polymer² was added slowly over the top and mix for further 20 mins increasing the rotor speed to effect visible bulk mixing.

### Example 1

Test Garments:

5 different garments where selected, to represent a variety of different clothes and materials:
Black woven dress
Black knitted dress
Black jeans
Yellow skirt
White blouse

Washing Conditions:

Using a Miele front loading washing machine, all garments were washed 20 times, with the exception of the black knitted dress, which was washed 10 times. The wash cycle was a 40° C. cotton cycle, using 12 litters and 3 rinses. The persil non-bio laundry capsule was placed in the bottom of the drum and the serum (were used) was poured into the fabric conditioner drawer.

Garments were tumble dried between washes 1, 2, 3, 4, 6, 7, 8, 9, 11, 12, 13, 14, 16, 17, 18, 19 and line dried between washes 5, 10, 15 and 20.

Wash Condition A:

Each item was washed 20 times* with a persil non-bio laundry capsule.

* with the exception of the black knitted dress, which was washed 10 times

Wash Condition 1:

Each item was washed 20 times* with a persil non-bio laundry capsule and 10 ml laundry serum composition of silicone serum formulation 1.

* with the exception of the black knitted dress, which was washed 10 times

Panel Assessment:

20 participants participated in the panel assessment. For each garment in turn, each participant was presented with a new, unwashed garment and informed that this was a new garment. They were then presented with an identical garment washed under Condition A and another identical garment washed under Condition 1. The order of the presentation of the washed garments was randomised.

They were asked out of these two garments:
Which garment looks newer?
Which garment feels newer?

The participants indicated their answers and then moved on to the next garment type.

TABLE 2
Results

| | |
|---|---|
| Which garment | Which garment |
| looks newer? | feels newer? |

| | Wash A | Wash 1 | Wash A | Wash 1 |
|---|---|---|---|---|
| Black woven dress | 10% | 90% | 15% | 85% |
| Black knitted dress | 10% | 90% | 15% | 85% |
| Black jeans | 10% | 90% | 35% | 65% |
| Yellow skirt | 25% | 75% | 5% | 95% |
| White blouse | 40% | 60% | 10% | 90% |

All garments treated with the serum look and feel newer. i.e. aging is prevented.

### Example 2

Test Garments:

3 different garments where selected, to represent a variety of different clothes and materials:
Black T-shirt
Black jeans
White blouse

Test Formulations:

The serum used in this example is the serum according to silicone serum formulation 1.

TABLE 3
Detergent compositions

| | I | II |
|---|---|---|
| Ingredient | w.t. % | w.t. % |
| MPG | 0.75 | 0.75 |
| TEA | 1.9 | 1.9 |
| Neodol 25-7 | 3.4 | 3.4 |
| LAS acid | 4.7 | 4.7 |
| Fatty acid | 0.7 | 0.7 |
| SLES (70% active) | 4.9 | 4.9 |
| Ethoxylated | 0.3 | 0.3 |
| polyether imine | | |
| Soil release polymer | 0.1 | 0.1 |
| Minors³ | <5 | <5 |
| Cationic polymer⁴ | — | 0.4 |
| Silicone⁵ | — | 3.33 |
| NaOH | to pH 7.5 | to pH 8.5 |
| Water | to 100 | to 100 |

Minors³ - rheology modifiers, opacifiers, perfume, enzymes, salts, dyes
Cationic polymer⁴ - Ucare ™ polymer LR400 ex. Dow
Silicone⁵ - Silicone added as a 30% emulsion ex. Wacker Silicone. The silicone comprised a carboxy group in a mid-chain pendent position.

Method of Preparing Example Detergent Formulations:

Water and hydrotropes were mixed together at ambient temperature for 2-3 minutes at a shear rate of 150 rpm using a Janke & Kunkel IKA RW20 overhead mixer. Salts and alkalis were added and mixed for 5 minutes prior to addition of surfactants and fatty acid. The mixture was exothermic and allowed to cool to <30° C. The Cationic polymer⁴ (when present), Silicone⁵ (when present) and any remaining components such as perfume, preservatives and dyes are added.

Washing Conditions:

Using a front loading washing machine, all garments were washed 10 times. The wash cycle was a 40° C. cotton cycle, using 12 litters and 3 rinses. Detergent was added 50 ml direct into the drum. Serum was added 10 ml in fabric conditioner drawer.

Washing Condition B:

Each item was washed 10 times with 50 ml Detergent II.

Washing Condition 2:

Each item was washed 10 times with 50 ml Detergent I and 10 ml Silicone Serum Formulation 1.

Panel Assessment:

20 participants participated in the visual panel assessment and 18 in the feel panel assessment. For each garment in turn, each participant was presented with a new, unwashed garment and informed that this was a new garment. They were then presented with an identical garment washed under Condition B and another identical garment washed under Condition 2. The order of the presentation of the washed garments was randomised.

They were asked out of these two garments:
Which garment looks newer?
Which garment feels newer?

The participants indicated their answers and then moved on to the next garment type.

TABLE 4
Results

| | Which garment looks newer? | | Which garment feels newer? | |
|---|---|---|---|---|
| | Wash B | Wash 2 | Wash B | Wash 2 |
| Black | 10% | 90% | 22% | 78% |
| T-shirt | | | | |
| Black | 45% | 55% | 33% | 67% |
| Jeans | | | | |
| White | 45% | 55% | 39% | 61% |
| Blouse | | | | |

All garments treated with the detergent and serum, rather than the detergent comprising silicone, look and feel newer. i.e. aging is prevented.

1. (canceled)

2. The method of claim 17, wherein the lubricant is a silicone.

3. The method of claim 17, wherein the lubricant is a silicone having a molecular weight of 1,000 to 500,000.

4. The method of claim 2, wherein the silicone is in the form of an emulsion.

5. The method of claim 4, wherein the particle size of the emulsion is in the range from 1 nm to 100 microns.

6. The method of claim 17, wherein the lubricant is selected from polydiakylsiloxanes and anionic functionalised silicones.

7. The method of claim 17, wherein the lubricant is selected from polydimethylsiloxane (PDMS) and carboxy functionalised silicones.

8. The method of claim 17, wherein the serum further comprises a cationic polymer.

9. The method of claim 8, wherein the laundry composition comprises 0.25 to 10 w.t. % cationic polymer.

10. The method of claim 8, wherein the cationic polymer has a molecular weight greater than 20 000 g/mol.

11. The method of claim 8, wherein the cationic polymer is selected from cationic polysaccharide polymers and acrylate polymers.

12. The method of claim 17, wherein the serum further comprises a perfume.

13. The method of claim 17, wherein the serum floats on the laundry liquid with which it is used.

14. (canceled)

15. The method of claim 17, comprising the steps of:
a. Pouring the laundry liquid into a washing machine drawer, drum or a dosing shuttle and
b. Pouring the serum composition according to any preceding claim on top of the laundry liquid.

16. The method of claim 17, wherein the serum is a Squid product which is added to the laundry process at the same time as the laundry detergent and/or a fabric conditioner.

17. A method comprising applying to clothes a combined composition for anti-aging of clothes, wherein the combined composition comprises,
i) a liquid serum, and
ii) at least one laundry liquid selected from a laundry detergent and a fabric conditioner,
wherein the serum comprises 1-60 w.t. % lubricant; and
wherein the serum comprises less than 4 w.t. % surfactant.

18. The method of claim 17, wherein the laundry liquid is a laundry detergent and a fabric conditioner.
